(19) United States
(12) Patent Application Publication
(10) Pub. No.: US 2002/0174070 A1
(43) Pub. Date: Nov. 21, 2002

(54) Transaction system

(76) Inventors: Toshihiko Eda, Ibaraki (JP); Takashi Kubokoya, Kanagawa (JP); Tatsuya Setoguchi, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/129,958

(22) PCT Filed: Dec. 27, 2000
(86) PCT No.: PCT/JP00/09332

(30) Foreign Application Priority Data
Sep. 14, 2000 (JP) 2000-280186

(51) Int. Cl. G06F 17/60

(52) U.S. Cl. 705/40; 705/39

(57) ABSTRACT

A settlement commission system 1 of the present invention includes that a supplier for supplying goods and a buyer for buying the goods make transactions using a computer system through a portal site 2. A settlement commission apparatus 5 totals the bills of charges generated by the transactions for each buyer. When the buyer makes an entry to the effect of accepting a charged amount of the bill to the settlement commission apparatus 5, the settlement commission apparatus 5 instructs a buyer-specified financial institution 6 specified by the buyer to send the charged amount to a supplier-specified financial institution 6. Thus, it is possible to batch-process settlements with a plurality of financial institutions, which are generated by transactions at a plurality of portal sites.

### TECHNICAL FIELD

The present invention relates to a settlement commission system for executing the commission of the settlement of charges generated by sales transactions at a portal site, and more particularly, to a settlement commission system capable of batch-processing settlements with a plurality of financial institutions, which are generated by sales transactions at a plurality of portal sites.

### BACKGROUND ART

Now, there are portal sites for handling various goods such as steel, foodstuffs and chemicals on Business to Business (B to B) transactions between companies, and sales transactions of goods are carried out through portal sites. In conventional portal sites, however, since no function are provided to settle funds generated by sales transactions, each portal site has had to build its own settlement function.

However, when each portal site tries to build its own settlement function, a problem arises in that each portal site has to connect with all financial institutions. In addition, since the amount of a purchase has to be counted and instructions for an amount of money to be sent has to be prepared for each customer, there is a problem of the large burden imposed in building and maintaining a settlement function.

Furthermore, if there are also portal sites desired for transactions at a financial institution side, the financial institution has to connect with all the portal sites. Thus, there is a problem that the burden imposed on the financial institution side similarly increases.

The present invention has been made with the above-described problems in mind, and it is an object of the present invention to provide a settlement commission system capable of batch-processing settlements with a plurality of financial institutions, which are generated by sales transactions at a plurality of portal sites, without any independent connections between the many portal sites and the many financial institutions.

### DISCLOSURE OF THE INVENTION

In order to achieve the foregoing object, a settlement commission method of the present invention defined in claim 1 is a method in which transactions are carried out between a supplier for supplying goods and a buyer for buying the goods through a portal site using a computer system, and the commission of the settlement of charges generated by the transactions is executed by a server. This settlement commission method is that the server totals the bills of charges generated in the transactions at the portal site, and when the buyer makes an entry to the effect of accepting a charged amount of the bills to the server, the server instructs a buyer-specified financial institution specified by the buyer to send the charged amount to a supplier-specified financial institution specified by the supplier.

According to the invention of claim 1, it is possible to batch-process settlements with a plurality of financial institutions, which are generated by sales transactions at a plurality of portal sites, without any independent connections between the many portal sites and the many financial institutions.

The settlement commission method of the invention defined in claim 2 is that when the buyer makes an entry to the effect of accepting the charged amount to the server, the server transmits verification of a payment amount sent by the buyer to the buyer-specified financial institution.

According to the invention of claim 2, even if the buyer-specified financial institution is a bank, it is possible to settle charges by collating a remittance instruction from the server with the payment amount verification.

The settlement commission method of the invention defined in claim 3 is that when the server receives, from the buyer-specified financial institution, a remittance result of the remittance instructed to the buyer-specified financial institution, the server deletes the remittance instruction to generate a settlement result based on the remittance result, and notifies the settlement result to the buyer.

According to the invention of claim 3, it becomes unnecessary for the buyer to carry out deletion work which has conventionally necessitated much labor, making it possible to greatly reduce the burden imposed on the buyer.

The settlement commission method of the invention defined in claim 4 is that the server notifies the bills of charges to the supplier, and allows the supplier make selections among the bills of charges.

According to the invention of claim 4, the bills can be distributed at the supplier's request, and useless bills can be deleted.

The settlement commission method of the invention defined in claim 5 is that the server receives processing states of the bills from the buyer, collects the processing states for each supplier, and notifies a result to the supplier.

According to the invention of claim 5, the supplier can always be aware of the processing state of the bill from the buyer's side.

A settlement commission apparatus of the invention defined in claim 6 is an apparatus for carrying out transactions between a supplier for supplying goods and a buyer for buying the goods through a portal site using a computer system, and for executing the commission of the settlement of charges generated by the transactions by a server. This settlement commission apparatus is including: a charge detail information notifying means for receiving, from the portal site, charge detail information as information regarding a bill of charges generated in the transactions at the portal site, for collecting the charge detail information for each buyer and for notifying the information to each buyer; and a remittance instructing means for instructing, when the buyer makes an entry to the effect of accepting a charged amount of the charge detail information notified by the charge detail information notifying means, a buyer-specified financial institution specified by the buyer to send the charged amount to a supplier-specified financial institution specified by the supplier.

According to the invention of claim 6, it is possible to batch-process settlements with a plurality of financial institutions, which are generated by sales transactions at a plurality of portal sites, without any independent connections between the many portal sites and the many financial institutions.

The settlement commission apparatus of the invention defined in claim 7 is further including payment amount verification transmitting means for transmitting, when the buyer makes an entry to the effect of accepting the charged amount of the charge detail information notified by the charge detail information notifying means, verification of a payment amount sent by the buyer to the buyer-specified financial institution.

According to the invention of claim 7, even if the buyer-specified financial institution is a bank, it is possible to settle charges by collating a remittance instruction from the settlement commission apparatus with the payment amount verification.

The settlement commission apparatus of the invention defined in claim 8 is further including settlement result notifying means for receiving a remittance result of the remittance instructed by the remittance instructing means from the buyer-specified financial institution, for deleting the remittance instruction to generate a settlement result based on the remittance result, and for notifying the settlement result to the buyer.

According to the invention of claim 8, it becomes unnecessary for the buyer to carry out deletion work which has conventionally necessitated much labor, making it possible to greatly reduce a burden imposed on the buyer.

The settlement commission apparatus of the invention defined in claim 9 is that the charge detail information notifying means notifies the charge detail information received from the portal site to the supplier, and allows the supplier to select the charge detail information.

According to the invention of claim 9, the bills can be distributed at the supplier's request, and useless bills can be deleted.

The settlement commission apparatus of the invention defined in claim 10 is further including processing state notifying means for receiving processing states of the charge detail information, which is notified to the buyer, from the buyer, for collecting the processing states for each supplier, and for notifying the collected processing states to the supplier.

According to the invention of claim 10, the supplier can always grasp the processing state of the bill in the buyer.

A buyer terminal of the invention defined in claim 11 is a terminal of a buyer for buying goods by carrying out transactions with a supplier for supplying the goods through a portal site using a computer system. The buyer terminal is that when a notice regarding bills for charges generated in the transactions at the portal site is received from a server, and the buyer makes an entry to the effect of accepting a charged amount of the bills, the server is allowed to instruct a buyer-specified financial institution specified by the buyer to send the charged amount to a supplier-specified financial institution specified by the supplier.

According to the invention of claim 11, it is possible to batch-process settlements with a plurality of financial institutions, which are generated by sales transactions at a plurality of portal sites, without any independent connections between the many portal sites and the many financial institutions.

The buyer terminal of the invention defined in claim 12 is that when the buyer makes an entry to the effect of accepting the charged amount, the acceptance is transmitted to the server, and the server is allowed to transmit verification of a payment amount sent by the buyer to the buyer-specified financial institution.

According to the invention of claim 12, even if the buyer-specified financial institution is a bank, it is possible to settle charges by collating a remittance instruction from the server with the payment amount verification.

The buyer terminal of the invention defined in claim 13 is that when the server receives a remittance result with respect to the remittance instruction of the charged amount, instructed by the buyer, from the buyer-specified financial institution, the server is allowed to delete the remittance instruction to generate a settlement result based on the remittance result, and the settlement result is received.

According to the invention of claim 13, it becomes unnecessary for the buyer to carry out deletion work which has conventionally necessitated much labor, making it possible to greatly reduce a burden imposed on the buyer.

A supplier terminal of the invention defined in claim 14 is a terminal of a supplier for providing information of goods to a portal site using a computer system and for selling goods by carrying out transactions with a buyer. The supplier terminal is that the supplier is prompted to make selection upon receiving bills of charges generated by transactions at the portal site from a server. When a result of the selection is transmitted to the server, the server is allowed to execute acceptance of a charged amount of the bills by the buyer, and when the buyer accepts the charge amount, the server is allowed to instruct a buyer-specified financial institution specified by the buyer to send the charged amount to a supplier-specified financial institution specified by the supplier.

According to the invention of claim 14, the bills can be distributed at the supplier's request, and useless bills can be deleted.

The supplier terminal of the invention defined in claim 15 is that the server receives processing states of the bills from the buyer, collects the processing states for each supplier, and the collected processing states are received.

According to the invention of claim 15, the supplier can always grasp the processing state of the bill in the buyer.

A recording medium for recording a settlement commission program in a settlement commission apparatus of the invention defined in claim 16 is a recording medium for recording a settlement commission program in a settlement commission apparatus for carrying out transactions between a supplier for supplying goods and a buyer for buying the goods through a portal site using a computer system, and for executing the commission of the settlement of charges generated by the transactions. The recording medium is including: a charge detail information notifying process for receiving, from the portal site, charge detail information as information regarding a bill of charges generated in the transactions at the portal site, for collecting the charge detail information for each buyer and for notifying the collected information to each buyer; and a remittance instructing process for instructing, when the buyer makes an entry to the effect of accepting a charged amount of the charge detail information notified by the charge detail information notification, a buyer-specified financial institution specified by the buyer to send the charged amount to a supplier-specified financial institution specified by the supplier.

According to the invention of claim 16, it is possible to batch-process settlements with a plurality of financial institutions, which are generated by sales transactions at a plurality of portal sites, without any independent connections between the many portal sites and the many financial institutions.

The recording medium for recording a settlement commission program in the settlement commission apparatus of the invention defined in claim 17 is further including a payment amount verification transmitting process for transmitting, when the buyer makes an entry to the effect of accepting the charged amount of the charge detail information notified by the charge detail information notification, payment amount verification sent by the buyer to the buyer-specified financial institution.

According to the invention of claim 17, even if the buyer-specified financial institution is a bank, it is possible to settle charges by collating a remittance instruction from the settlement commission apparatus with the payment amount verification.

The recording medium for recording a settlement commission program in the settlement commission apparatus of the invention defined in claim 18 is further including a settlement result notifying process for receiving a remittance result with respect to a remittance instruction instructed by the remittance instruction process from the buyer-specified financial institution, for deleting the remittance instruction to generate a settlement result based on the remittance result, and for notifying the settlement result to the buyer.

According to the invention of claim 18, it becomes unnecessary for the buyer to carry out deletion work which has conventionally necessitated much labor, making it possible to greatly reduce a burden imposed on the buyer.

The charge detail information notifying process of the recording medium for recording a settlement commission program in the settlement commission apparatus of the invention defined in claim 19 is notifying the charge detail information received from the portal site to the supplier, and allowing the supplier to make selection of the charge detail information.

According to the invention of claim 19, the bills can be distributed at the supplier's request, and useless bills can be deleted.

The recording medium for recording a settlement commission program in the settlement commission apparatus of the invention defined in claim 20 is further including a processing state notifying process for receiving processing states, from the buyer, of the charge detail information notified to the buyer, for collecting the processing states for each supplier, and for notifying the collected processing states to the supplier.

According to the invention of claim 20, the supplier can always grasp the processing state of the bill in the buyer.

### BRIEF DESCRIPTION OF THE DRAWINGS

FIG. 1 is a block diagram showing a configuration of a settlement commission system according to an embodiment of the present invention.

FIG. 2 is a flowchart for illustrating a member information registration process in the settlement commission system 1 shown in FIG. 1.

FIG. 3 is a view showing an example of a registration screen of a financial institution in the member information registration process shown in FIG. 2.

FIG. 4 is a view showing an example of a display screen of member information in the member information registration process shown in FIG. 2.

FIG. 5 is a flowchart for illustrating a sales transaction of goods on a portal site 2 shown in FIG. 1.

FIG. 6 is a flowchart for illustrating a settlement commission process in the settlement commission system 1 shown in FIG. 1.

FIG. 7 is a view showing an example of a verification screen of bill contents by a supplier in the settlement commission process shown in FIG. 6.

FIG. 8 is a view showing an example of a log-in screen in the settlement commission process shown in FIG. 6.

FIG. 9 is a view showing an example of a verification screen of charge contents in the settlement commission process shown in FIG. 6.

FIG. 10 is a view showing an example of the verification screen of the charge contents in the settlement commission process shown in FIG. 6.

FIG. 11 is a view showing an example of the acceptance screen of the charge contents in the settlement commission process shown in FIG. 6.

FIG. 12 is a view showing an example of a screen for specifying and changing a financial institution in the settlement commission process shown in FIG. 6.

FIG. 13 is a view showing an example of a bill list presented to a supplier in settlement commission process shown in FIG. 6.

FIG. 14 is a view showing an example of a verification screen for verifying detailed contents of a bill selected in the bill list shown in FIG. 13.

FIG. 15 is a view showing an example of a scheduled money receipt list presented to the supplier in the settlement commission process shown in FIG. 6.

FIG. 16 is a view showing an example of the verification screen of the charge contents in the settlement commission process shown in FIG. 6.

FIG. 17 is a view showing an example of a screen for specifying a financial institution in the settlement commission process shown in FIG. 6.

FIG. 18 is a view showing an example of a screen for displaying payment history in the settlement commission process shown in FIG. 6.

### BEST MODES FOR CARRYING OUT THE INVENTION

Next, description will be made for a settlement commission system according to an embodiment of the present invention with reference to the accompanying drawings.

(First Embodiment)

1. System Configuration

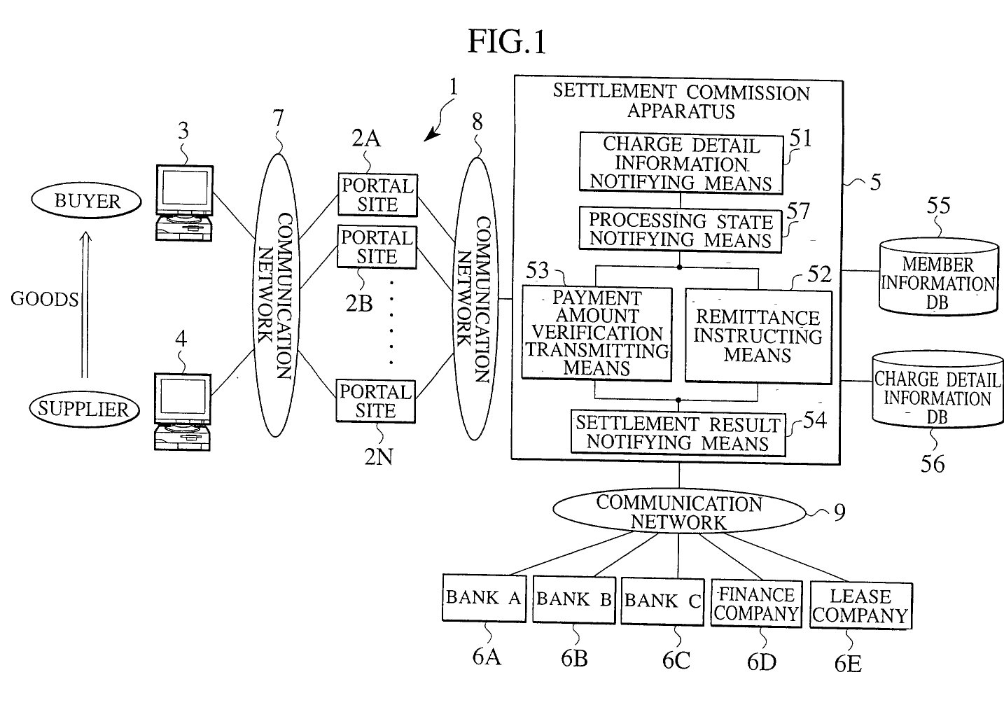

As shown in FIG. 1, a settlement commission system 1 of the embodiment includes: a buyer terminal 3 of a buyer company for buying goods by accessing portal sites 2A, 2B, . . . , and 2N; a supplier terminal 4 of a supplier company for supplying goods information to the portal sites 2A, 2B, . . . , and 2N; a settlement commission apparatus 5 functioning as a server to execute the commission of the settlement of charges generated by transactions between the supplier and the buyer; and financial institutions 6A, 6B, . . . , and 6E for settling charges generated by the transactions made by the buyer or the supplier, or for performing collection of charges.

In this case, the buyer terminal 3, the supplier terminal 4, and the portal sites 2A, 2B, . . . , and 2N are interconnected by a communication network 7. The portal sites 2A, 2B, . . . , and 2N, and the settlement commission apparatus 5 are interconnected by a communication network 8. The settlement commission apparatus 5 and the financial institutions 6A, . . . , and 6E are interconnected by a communication network 9. The communication networks 7, 8 and 9 are composed of communication lines such as Internet, dial-up, a dedicated line, VPN, and a radio connection. Especially, the communication network 8 is connected based on protocol of TCP/IP or SAP R3, and the communication network 9 is connected based on Zengin protocol (Standard Communication Protocol of Japanese Bankers Association), or a SWIFT format in overseas remittance.

Further, the settlement commission apparatus 5 includes: charge detail information notifying means 51 for receiving charge detail information as information regarding a bill from the portal sites 2A, 2B, . . . , and 2N, for collecting charge detail information for each buyer, and for notifying the information to each buyer; remittance instructing means 52 for instructing a financial institution to send a charged mount when the buyer makes an entry to the effect of acceptance regarding the charged mount of the charge detail information notified by the charge detail information notifying means 51; payment amount verification transmitting means 53 for transmitting payment amount verification offered by the buyer to the financial institution when the buyer makes an entry to the effect of acceptance regarding the charged amount of the charge detail information notified by the charge detail information notifying means 51; settlement result notifying means 53 for receiving from the financial institution a remittance result with respect to the remittance instruction made by the remittance instructing means 52, for deleting the remittance instruction based on the remittance result to generate a settlement result, and for notifying the settlement result to the buyer; and processing state notifying means 57 for receiving processing states of the charge detail information from the buyer, for collecting the processing states for each supplier, and for notifying the processing states to the supplier.

The settlement commission apparatus 5 is a server composed of a normal computer system including a CPU for executing various processing operations, and storing means for storing commands of the processing operations. The settlement commission apparatus 5 is managed by a so-called Internet provider, and connected through the Internet to a not-shown host computer. When access is made from the buyer terminal 3 or the supplier terminal 4 through the communication network 7 or 8, the settlement commission apparatus 5 provides a homepage for the buyer or the supplier. On this homepage, information regarding contents of a bill, counting of a monthly payment amount, verification of the payment amount or the like is displayed.

In addition, the settlement commission apparatus 5 includes a member information database 55 for storing member information of a buyer or a supplier as a member of the settlement commission system 1, and a charge detail information database 56 for storing charge detail information as information regarding a bill of charges generated by transactions at the portal sites 2A, 2B, . . . , and 2N.

Here, the member information database 55 stores information such as a company name, an office name, a division name in charge, a zip code, an address, a name of a person in charge, a telephone number, a FAX number, a name of a specified financial institution, a type of business, a portal ID, a portal member ID, a contract ID, and a user ID for individual buyers and suppliers as member information thereof.

The charge detail information database 56 stores information such as a control ID, a charge number, a buyer's name, a contract ID and a user ID of a buyer, a supplier's name, a contract ID and a user ID of a supplier, a name of goods, a goods number, a volume of goods, a unit price, a name of a financial institution, and a due date of payment for individual charge details as charge detail information.

The financial institutions include a bank, a finance company, a lease company and the like. Banks 6A, 6B and 6C make settlements according to the remittance instruction of the settlement commission apparatus 5; a finance company 6D serves as a collection agency based on the remittance instruction of the settlement commission apparatus 5; and a lease company 6E collects money for goods leased based on the remittance instruction of the settlement commission apparatus 5. These financial institutions 6A, 6B, . . . , and 6E make transfer commission contracts with the buyer and the supplier beforehand, transfer commission contract documents are submitted by the buyer and the supplier, and these contract documents are saved by the settlement commission apparatus 5 and the financial institutions.

2. Operation

Next, description will be made for each processing carried out by the settlement commission system 1 of the embodiment with reference to the accompanying drawings.

2-1. Member Information Registration Process

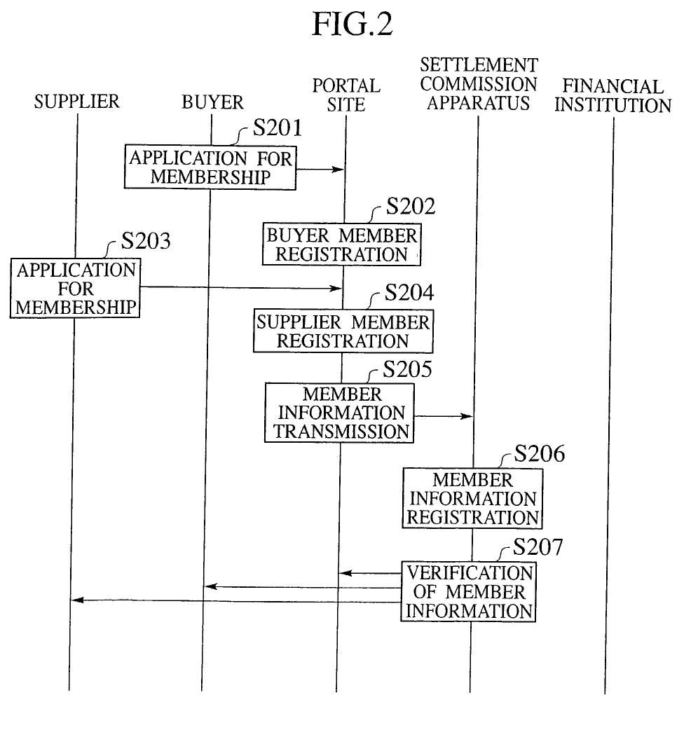

First, based on a flowchart of FIG. 2, description will be made for a member information registration process of a buyer and a supplier by the settlement commission system 1 according to the embodiment.

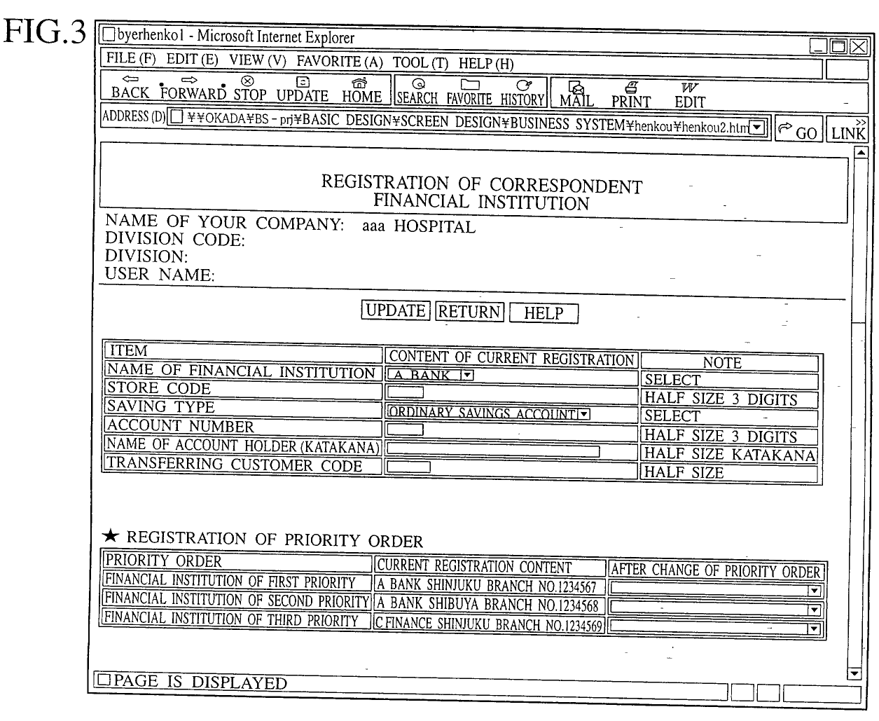

A buyer trying to use the commission of the settlement by the settlement commission system 1 of the embodiment applies for membership by accessing a portal site 2 for transactions from the buyer terminal 3 (S201). In this case, the buyer enters member information such as a company name, an office name, and a name of a specified financial institution. Especially, the entry of the specified financial institution is executed on an input screen as that shown in FIG. 3. A plurality of buyer-specified financial institutions for settlements of the buyers can be specified, and a priority can also be specified.

After the entry of the member information, the portal site 2 offers a portal member ID, and carries out buyer member registration (S202).

Similarly, a supplier applies for membership by accessing the portal site 2 from the supplier terminal 4 (S203), and enters member information such as a company name, an office name, and a supplier-specified financial institution for settlement of the supplier. Based on the above member information, the portal site 2 offers a portal member ID, and carries out supplier member registration (S204).

In performing the member registration as described above, the portal site 2 adds a portal ID for specifying a portal site to the member information, and transmits the member information to the settlement commission apparatus 5 (S205).

Then, upon having received the member information, the portal ID and the portal member ID, the settlement commission apparatus 5 offers a contract ID and a user ID, which are a member ID of the settlement commission apparatus 5, and registers the member information (S206), and then stores the member information in the member information database 55.

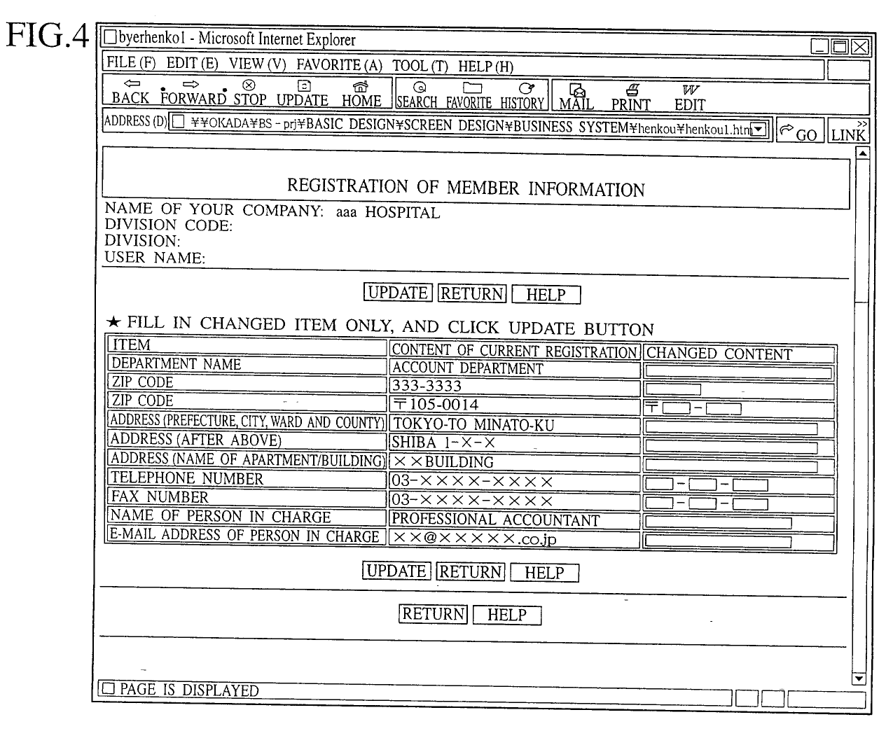

After the member information has been registered, a registration verification screen as that shown in FIG. 4 is presented to each of the supplier 4, the buyer 3 and the portal site 2, and the member information is verified (S207), thus completing the registration process.

The specified financial institution and the member information can be changed on the screens of FIGS. 3 and 4, respectively.

2-2. Sales Transaction of Goods on Portal Site

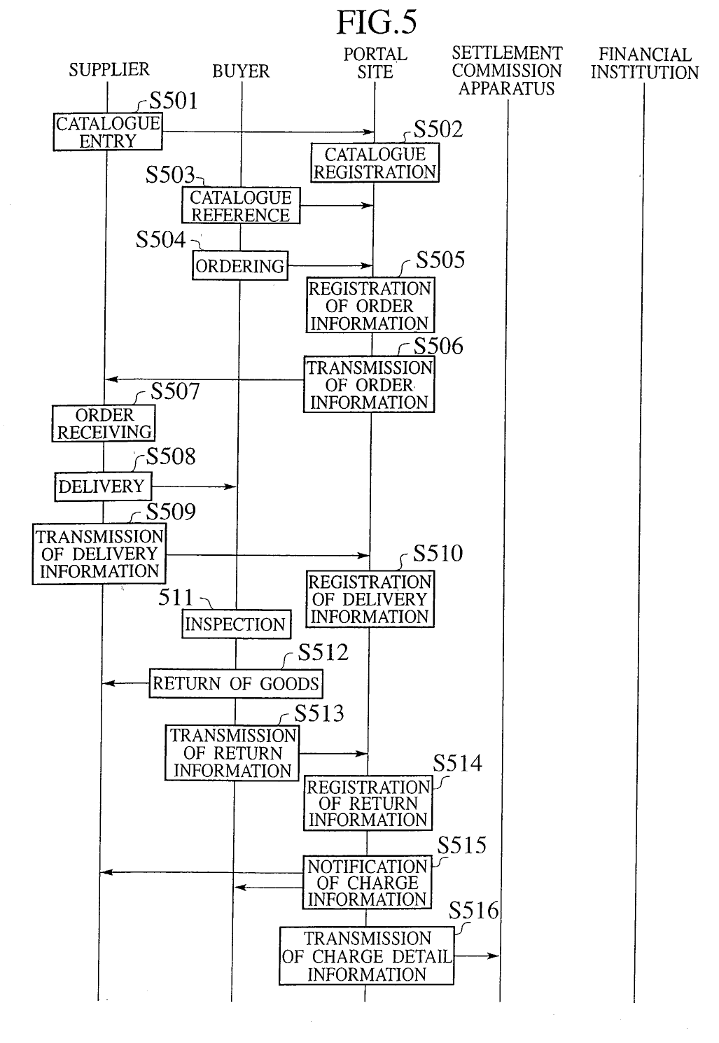

Next, description will be made for sales transactions of goods on the portal site 2 based on a flowchart of FIG. 5.

First, the supplier accesses the portal site 2 from the supplier terminal 4, and makes an entry of goods to be sold in a catalogue of the portal site 2 (S501). Upon reception of the entry, the portal site 2 registers the goods in the catalogue (S502).

Then, the buyer accesses the portal site 2 from the buyer terminal 3, and refers to the catalogue (S503). When there are goods the buyer desires to buy, the buyer sends an order to the portal site 2 (S504). Upon reception of the order, the portal site 2 receives and registers order information thereof (S505).

Then, the order information is transmitted to the supplier terminal 4 of the supplier (S506). The supplier receives the order based on the order information (S507), delivers the ordered goods to the buyer (S508), and transmits delivery information to the portal site 2 (S509). Then, the portal site 2 registers the delivery information (S510).

The buyer having received the goods inspects the delivered goods (S511), returns the goods to the supplier if the goods are defective (S512), and transmits return information to the portal site 2 (S513). Then, the portal site 2 registers the return information (S514).

After the registration of the delivery information and the return information at the portal site 2, the portal site 2 creates charge information based on the delivery information and the return information, and notifies this charge information to both of the supplier and the buyer (S515). Then, the portal site 2 extracts information necessary for settlement from the charge information to generate charge detail information, and transmits this charge detail information to the settlement commission apparatus 5 (S516), thus completing the sales transaction of the goods on the portal site 2.

If an error or unnecessary information is contained in the charge detail information, the portal site 2 transmits charge detail information having a control ID added to indicate a status of a change, deletion or the like to the settlement commission apparatus 5. The settlement commission apparatus 5 specifies a bill based on a bill number, and executes updating, deletion or the like according to the status of the control ID.

2-3. Settlement Commission Process

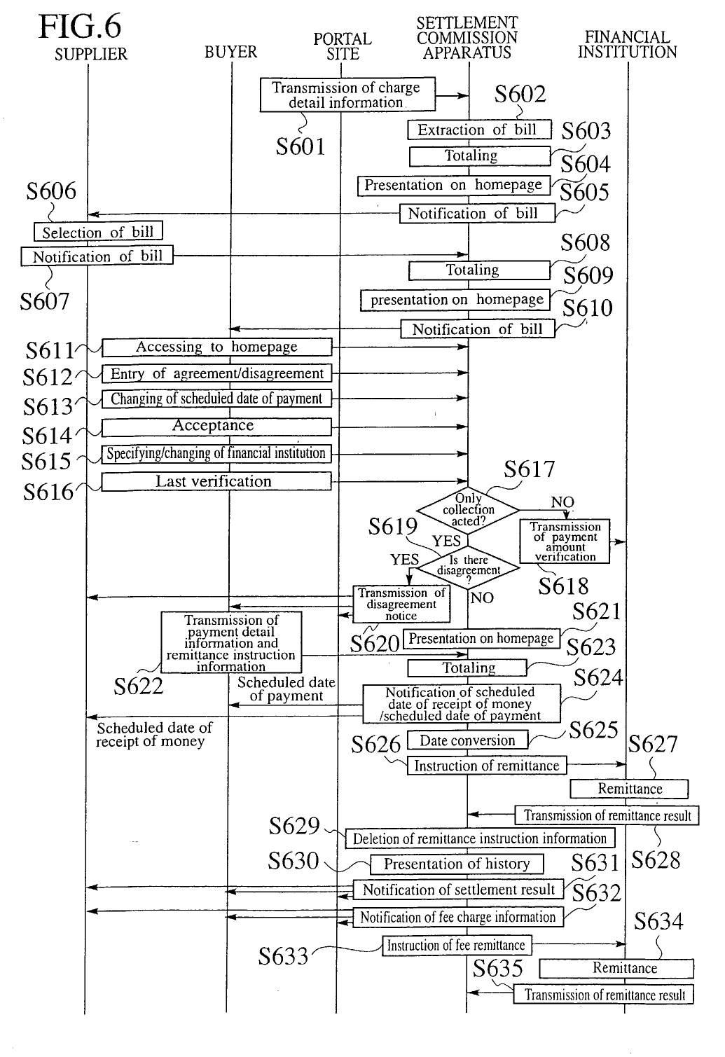

Next, description will be made for a settlement commission process by the settlement commission apparatus 5 according to the embodiment based on a flowchart of FIG. 6.

As shown in FIG. 6, when charge detail information is transmitted from the contracted portal site 2A, 2B, . . . , or 2N (S601), the settlement commission apparatus 5 receives the charge detail information, and stores the same in the charge detail information database 56.

Then, the settlement commission apparatus 5 periodically reads the charge detail information stored in the charge detail information database 56, and extracts the charge detail information registered in the settlement commission system 1 by both of the supplier and the buyer (S602). Then, monthly or weekly collection of the extracted charge detail information is carried out for each supplier (S603), contents of a bill for each supplier are presented on the homepage for the suppliers based on the collection (S604), and the contents of the bill are notified to the supplier by electronic mail or the like (S605).

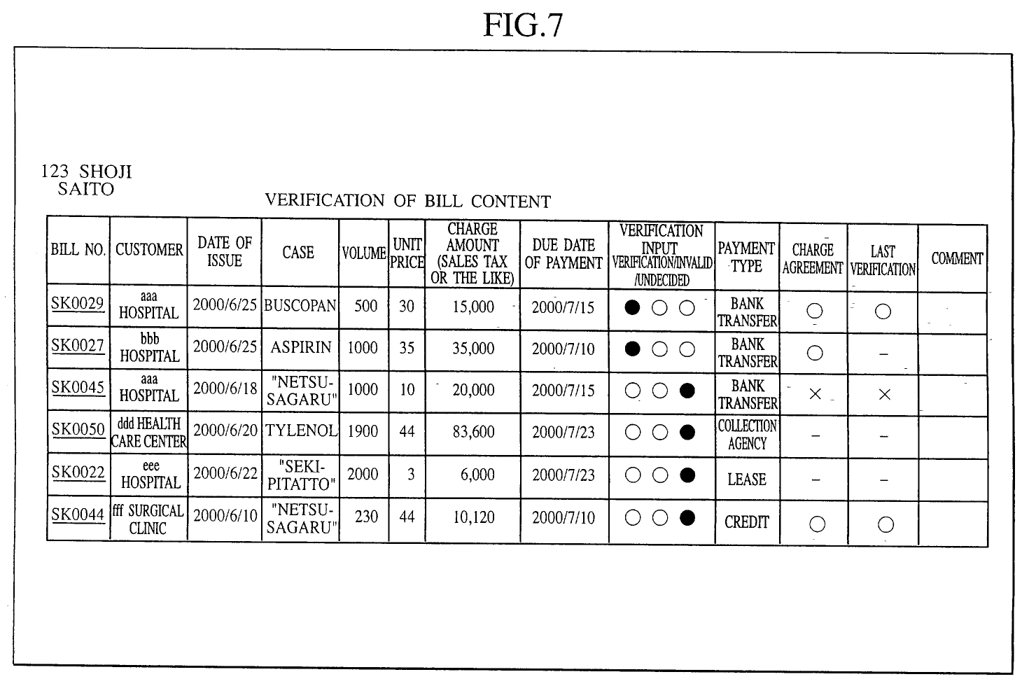

Upon having been notified of the bill, the supplier selects each bill on a verification screen of bill contents shown in FIG. 7 (S606). In this selection of the bill, verification as to whether each bill is processed by the settlement commission system 1 or not is entered. On the verification screen shown in FIG. 7, for a bill desired to be processed by the settlement commission system 1, “VERIFICATION” is selected in a section of verification input; “INVALID” is selected for a bill that can be omitted; and “UNDECIDED” is selected for a bill undecided for processing.

Thus, even if a duplicate bill is issued because of a change of a bill, the duplicate bill can be made invalid by selecting the bill as described above. Therefore, unnecessary bills can be deleted.

Further, the supplier can select a method of paying for each bill from a section of payment types on the verification screen of FIG. 7. As the payment method that can be selected here, there are bank transfer, collection agency, lease and credit.

Accordingly, since the supplier can enter each bill processing method for each bill, the supplier can select a desired processing method for each bill.

In addition, on the verification screen of FIG. 7, whether the buyer agrees to a bill or not is shown in a section of charge agreement, and whether last verification by an accounting division chief of the buyer has been entered or not is shown in a section of last verification.

After the completion of the bill selection, the supplier notifies the selected bill to the settlement commission apparatus 5 (S607).

Upon having received the selected bill, the settlement commission apparatus 5 executes monthly or weekly counting for individual suppliers and buyers (S608), presents charge contents to the buyer on the homepage for the buyer based on the counting (S609), and notifies the charge contents to the buyer by electronic mail or the like (S610).

The charge contents notified in this event contain information regarding a bill number, a buyer name, a contract ID, a user ID, a supplier name, a name of goods, a goods number, a volume of goods, a unit price, an amount of money, a name of a financial institution, a date of settlement, a scheduled date of payment and the like.

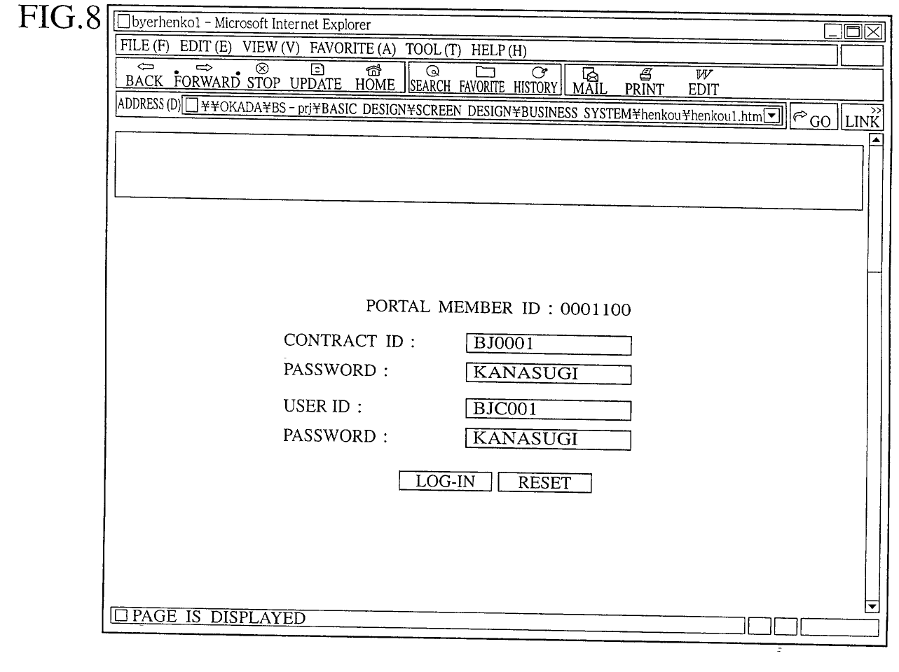

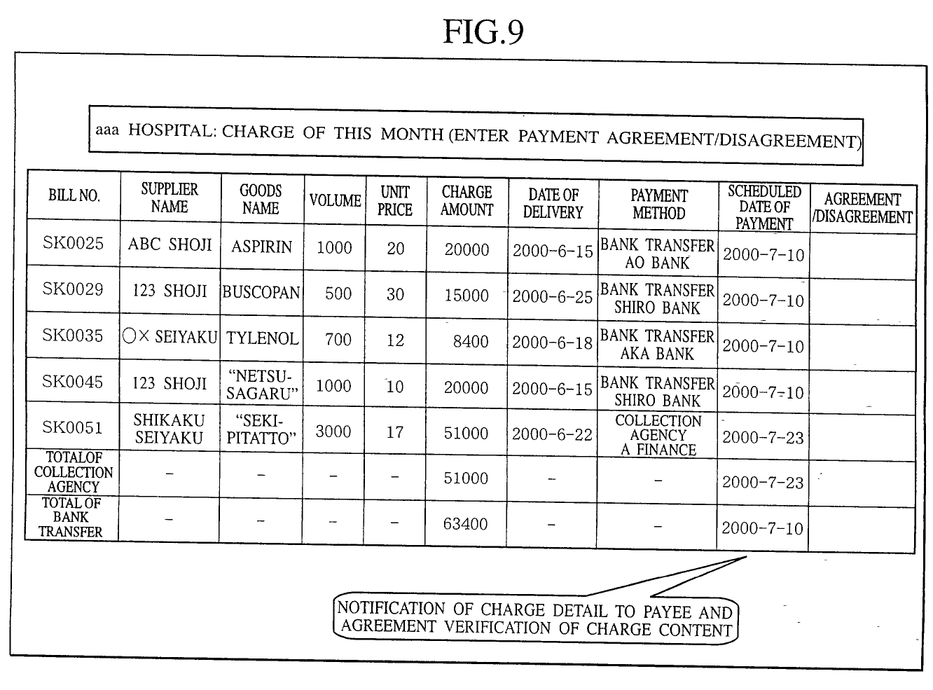

Then, the buyer enters a contract ID and a user ID on a log-in screen as that shown in FIG. 8 from the buyer terminal 3 to access the homepage for the buyer (S611), and verifies the bill contents by opening a verification screen as that shown in FIG. 9.

As shown in FIG. 9, on the verification screen, a bill number, a supplier name, a name of goods, a volume of goods, a unit price, a charged amount, a date of delivery, a payment method, and a scheduled date of payment are described, and in addition, a total amount of money to be paid through a collection agency, and a total amount of money to be paid through bank transfer are also described.

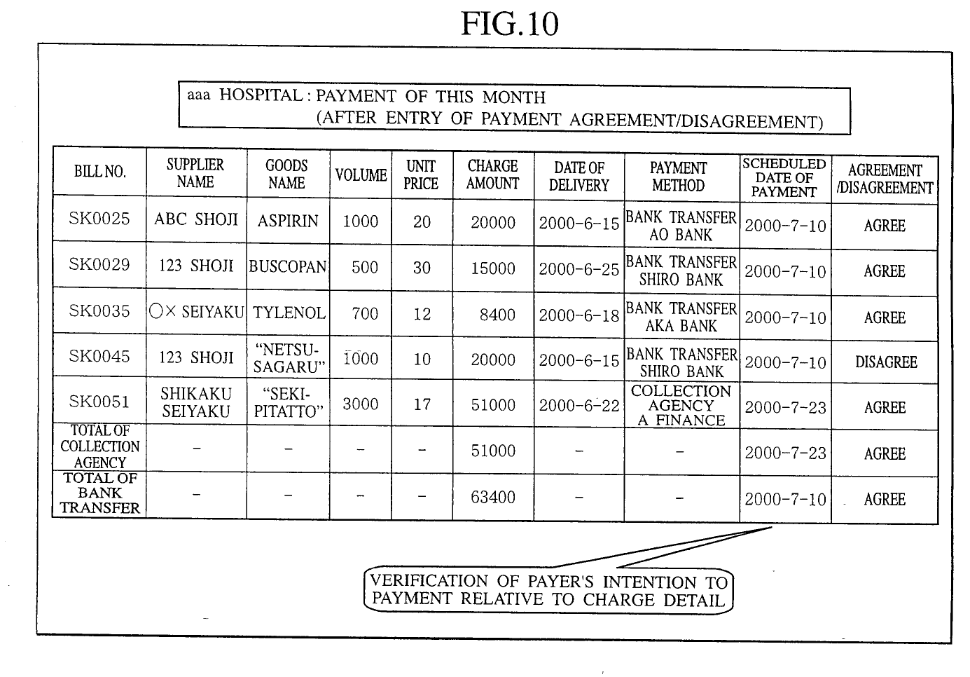

Then, the buyer verifies the bill contents on the verification screen, and enters “AGREE” or “DISAGREE” for each bill (S612). FIG. 10 shows an example of a verification screen after the above entry. On this verification screen, “DISAGREE” has been entered for the bill of the number SK0045, while “AGREE” has been entered for other bills. Accordingly, the amount of money indicated by “DISAGREE” is subtracted from the total amount of money to be paid through bank transfer, and the resultant amount is displayed.

If there is a change in a scheduled date of payment displayed on the verification screen shown in FIG. 10, the change of the scheduled date of payment is entered (S613).

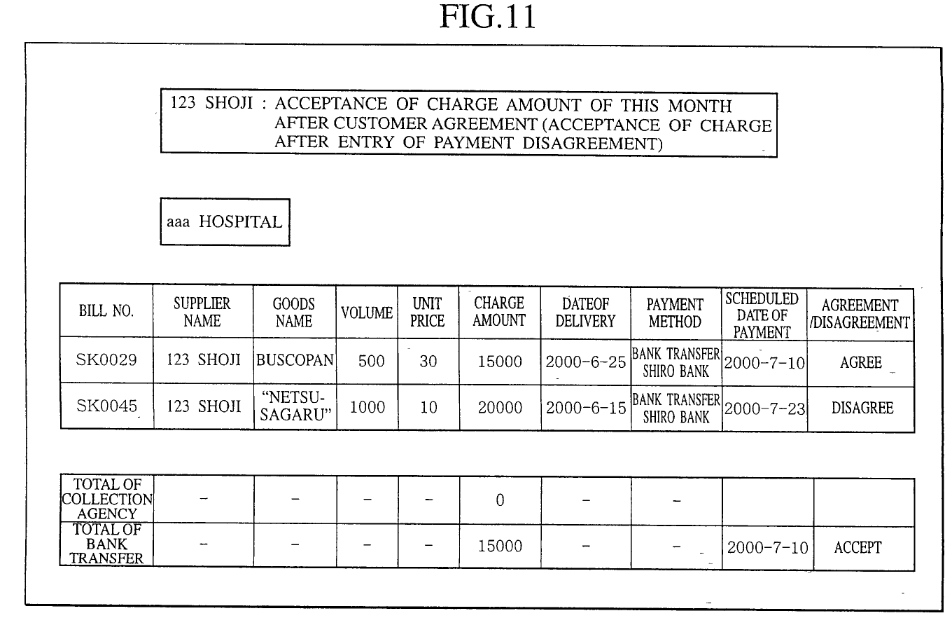

After the entry of “AGREE” and “DISAGREE”, and the scheduled date of payment, respective bills are arranged for each scheduled date of payment and for each supplier, and acceptance of the arrangement by a person in charge of accounting is entered (S614). For example, among bills shown in FIG. 10, bills concerning “123 SHOJI” are arranged as shown in FIG. 11, and acceptance of payment to 123 SHOJI is entered. Here, in FIG. 11, since agreement is not met for the bill of SK0045, acceptance has been entered for a total amount of money for bank transfer excluding the charged amount of SK0045.

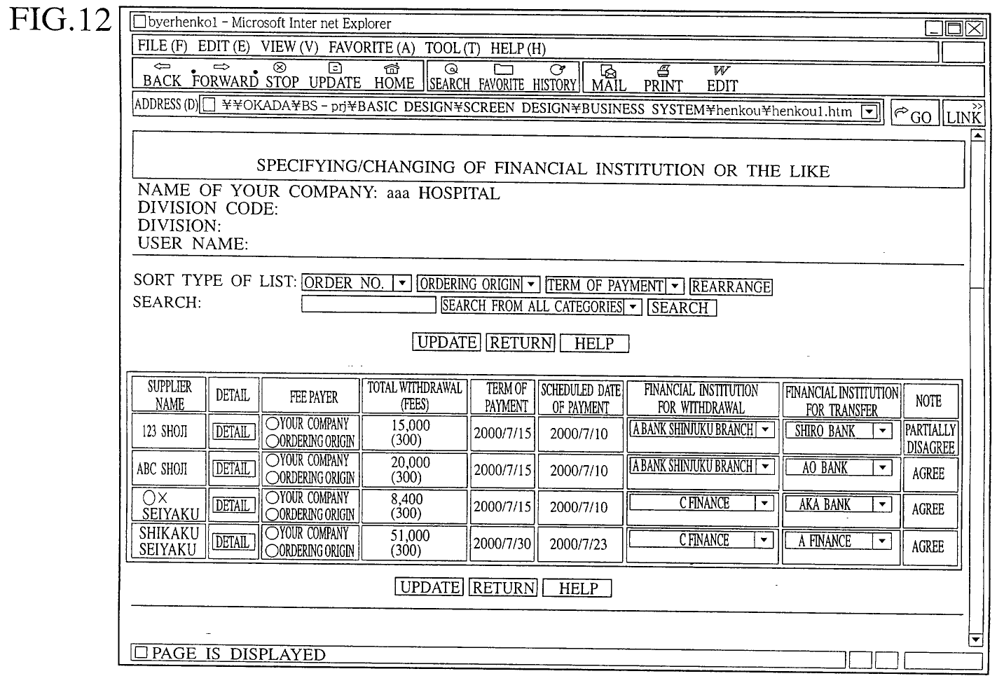

Then, with the above acceptance, a financial institution is specified or changed on a specification screen shown in FIG. 12 (S615), and last verification by the accounting division chief with respect to the acceptance of the bill is lastly entered, establishing a payment amount (S616).

Here, from the steps S611 to S616, each information, entered by the buyer, regarding the agreement/disagreement, the change of the scheduled date of payment, the acceptance, the specification/change of the financial institution, or the last verification is transmitted to the settlement commission apparatus 5 for each entry of such information. Upon having received the information, the settlement commission apparatus 5 selects the information for each supplier, and presents the information on the homepage of the supplier each time.

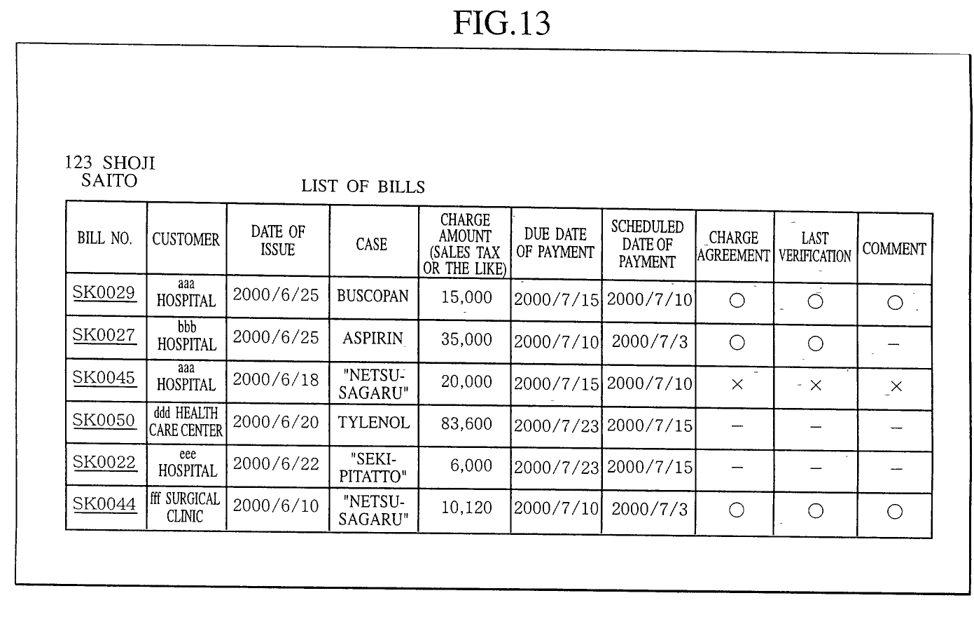

For example, as shown in FIG. 13, a processing state of each bill charged to each buyer is displayed on a homepage of the supplier “123 SHOJI”. In FIG. 13, for a bill of the number SK0029, throughout the processing from charge agreement to last verification, “AGREE” has been entered by the buyer, and for the bill of SK0045, “DISAGREE” has been entered throughout the processing.

Thus, by accessing his/her own homepage, the supplier can always grasp a processing state of the bill that he/she charges to the buyer.

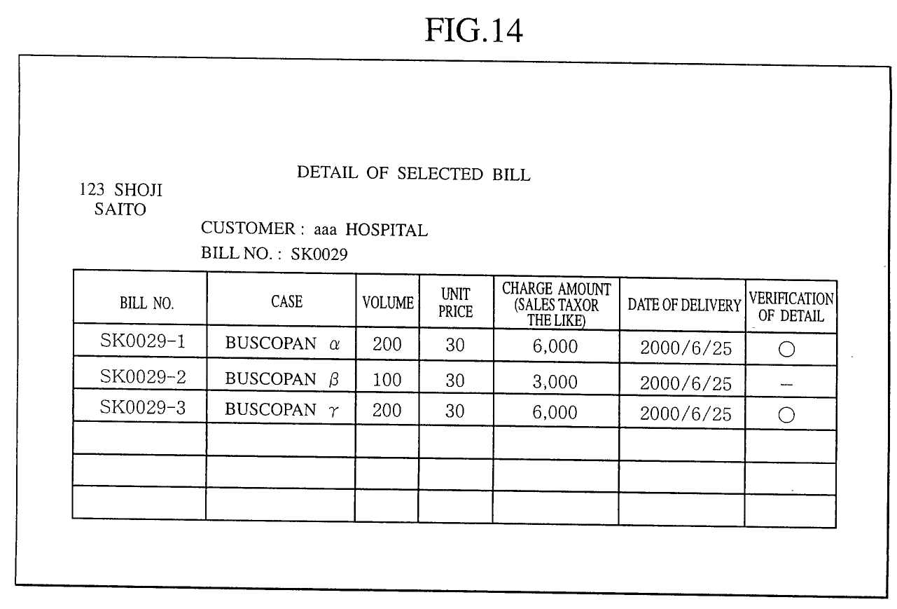

Further, by clicking the bill number of a bill list shown in FIG. 13, a detail of a bill as shown in FIG. 14 is displayed, making it possible to verify detailed contents for each bill. FIG. 14 shows the detail of the bill of the number SK0029 shown in FIG. 13.

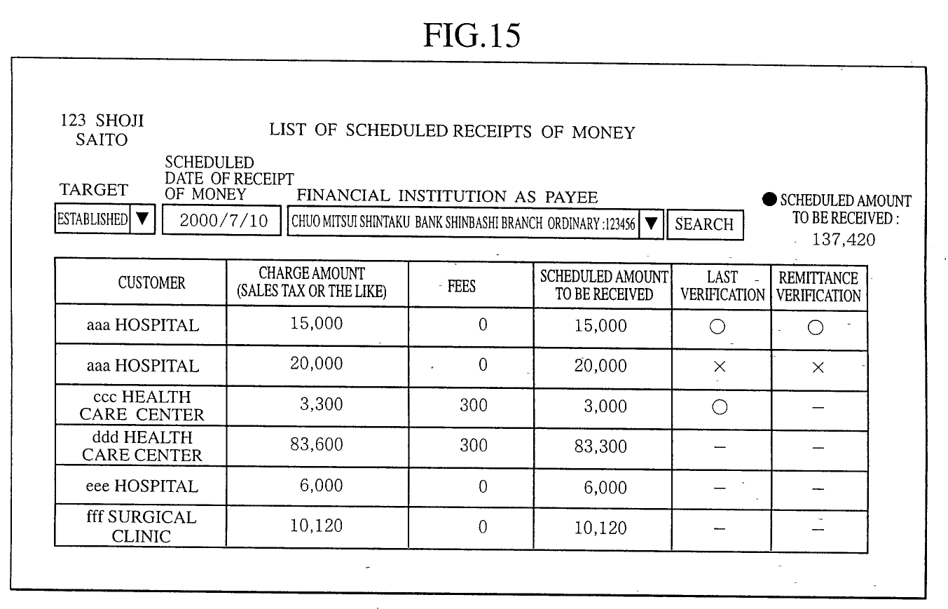

In addition, on the homepage of the supplier, when a scheduled date of receiving money is specified, a scheduled receipt list of bills scheduled to be paid on the specified date is displayed as shown in FIG. 15. FIG. 15 shows bills scheduled to be paid on July 10, each specifically showing a charged amount, a fee, a scheduled amount to be received, agreement of last verification by the buyer, and completion of remittance by a bank.

Then, after the entry of the last verification by the buyer to establish the payment amount in the above-described step S616, the settlement commission apparatus 5 determines whether the payment method of the bills includes only the collection agency or also includes the bank transfer (S617). If payment through the bank transfer is included, then the settlement commission apparatus 5 transmits verification of the payment amount sent by the buyer to a buyer-specified financial institution, from which money is withdrawn, by automatic FAX or electronic mail (S618).

The verification of the payment amount is transmitted to the bank. This is because, in order to withdraw money from a bank account of the buyer, the bank of withdrawal cannot settle the charge only by the remittance instruction from the settlement commission apparatus 5 to be described later and also because the bank receives verification of the payment amount directly from the buyer as a principal for settlement. Thus, the verification of the payment amount transmitted here must be sent from the buyer.

As described above, since the verification of the payment amount is transmitted to the bank of withdrawal, the charge can be settled by collating later-described remittance instruction from the settlement commission apparatus 5 with the verification of the payment amount.

In addition, in FIG. 6, the buyer enters the agreement/disagreement, the acceptance, the last verification and the like, and the buyer accepts the charged amount. However, in the case of collection performed by a finance company, the supplier may accept the charged amount and may instruct the charged amount for each buyer to the finance company. In this case, the buyer enters disagreement if he/she does not agree to the charged amount. However, the buyer needs not enter the acceptance, the last verification or the like if he/she agrees.

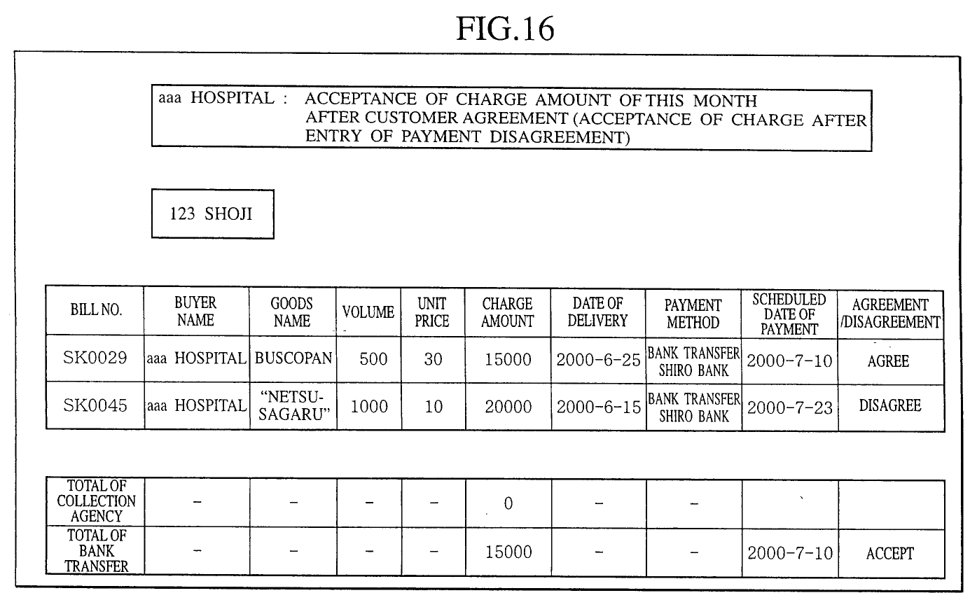

Then, if there is a bill of disagreement among bills (S619), the settlement commission apparatus 5 notifies the disagreement to the portal site 2, the supplier terminal 4, and the buyer terminal 3 by electronic mail or the like (S620), and presents the bill of disagreement on the homepage of the supplier as shown in FIG. 16 (S621).

On the other hand, in addition to the entry of the charge detail information from the portal site 2 as described above, payment detail information and remittance instruction information can be directly entered from the buyer terminal 3 (S622).

Here, since the payment detail information entered from the buyer terminal 3 is similar to charge detail information, money is sent and processed as in the case of the charge detail information.

Accordingly, since the payment detail information can be directly entered from the buyer terminal 3, an accounting system of the buyer and the settlement commission apparatus 5 are linked with each other, making it possible to automate payment to the bank.

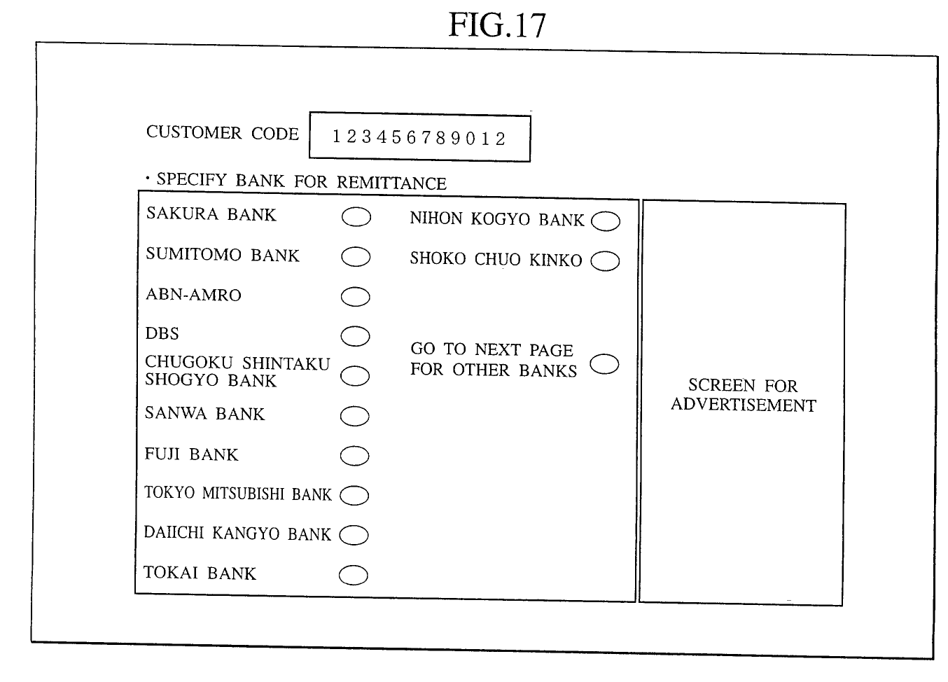

In addition, in the case of the entry of the remittance instruction information from the buyer terminal 3, remittance is instructed by specifying a bank as a receiver on a display screen as that shown in FIG. 17.

Accordingly, since the buyer can directly enter the remittance instruction information, the buyer can execute remittance among a plurality of banks by the settlement commission apparatus 5.

Then, the settlement commission apparatus 5 collects the charge detail information, the payment detail information and the remittance instruction information (S623), and notifies a scheduled date of payment and a scheduled date of receipt to the buyer and the supplier, respectively (S624). Further, the settlement commission apparatus 5 converts data for each financial institution (S625), and instructs a buyer-specified financial institution specified by the buyer to send money (S626).

The bank of the buyer-specified financial institution that has received the remittance instruction collates the received remittance instruction with the payment amount verification transmitted in the step S618, sends an amount of money to be withdrawn to the supplier-specified financial institution specified by the supplier based on the above collating (S627), and then transmits a remittance result to the settlement commission apparatus 5 (S628).

In the case of collection performed by the finance company, an amount of money to be withdrawn is collected from the bank account of the buyer, which is registered beforehand based on the received remittance instruction, and is sent to the supplier-specified financial institution (S627). A remittance result is then transmitted to the settlement commission apparatus 5 (S628).

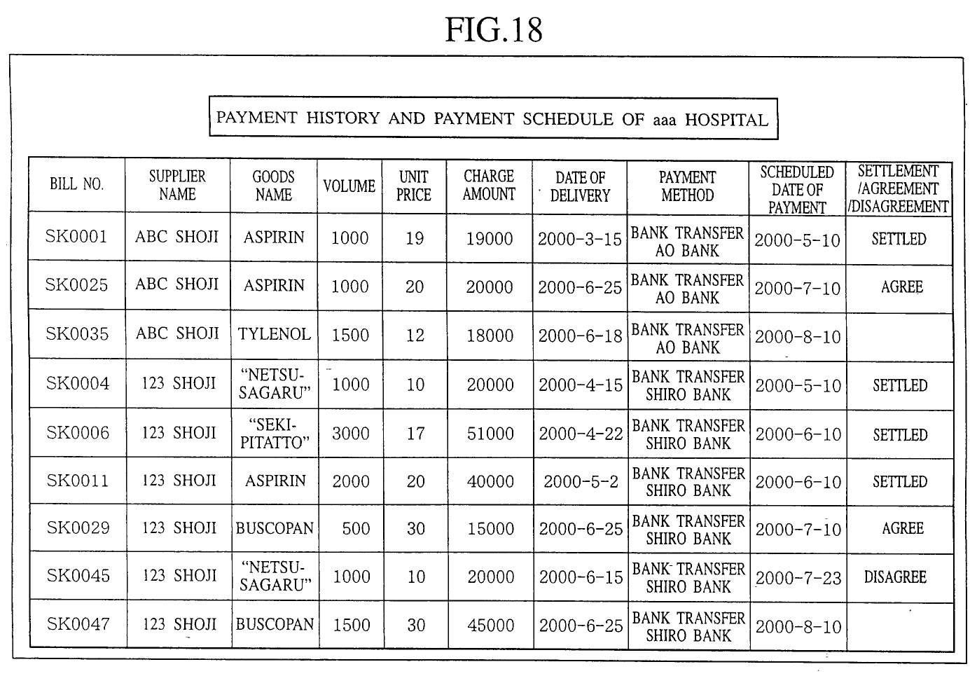

Upon having received the remittance result, the settlement commission apparatus 5 deletes the remittance instruction information based on the remittance result (S629), generates a settlement result to present payment history, as that shown in FIG. 18, on the homepages of the buyer and the supplier (S630). At the same time, the settlement commission apparatus 5 generates the settlement result to be notified to the portal site 2, the buyer terminal 3 and the supplier terminal 4 (S631).

Thus, since the settlement commission apparatus 5 deletes the remittance instruction information to generate the settlement result, it becomes unnecessary for the buyer to carry out deletion work, which has conventionally necessitated much labor, thus making it possible to greatly reduce a burden imposed on the buyer.

Moreover, the settlement commission apparatus 5 notifies charge information of fees for the commission of the settlement to the buyer terminal 3, the supplier terminal 4 and the portal site 2 (S632), respectively. At the same time, the settlement commission apparatus 5 instructs the buyer-specified financial institution, the supplier-specified financial institution, and the portal site-specified financial institution to send money for the fees (S633). When the remittance of the fees is performed (S634), the settlement commission apparatus 5 receives remittance results (S635). Thus, the settlement commission process by the settlement commission apparatus 5 is finished.

As described above, in the settlement commission system 1 of the embodiment, the settlement commission apparatus 5 collects the charge detail information sent from the portal sites 2A, 2B, . . . , and 2N, notifies the information to each buyer, and instructs the financial institutions 6A, 6B, . . . , and 6E to send money. Thus, the portal sites 2A, 2B, . . . , and 2N can build settlement functions only by connecting to the settlement commission apparatus 5.

Similarly, the financial institutions 6A, 6B, . . . , and 6E can also obtain remittance instructions from the portal sites 2A, 2B, . . . , and 2N only by connecting to the settlement commission apparatus 5. Thus, it becomes unnecessary to make any independent connections to all the portal sites 2A, 2B, . . . , and 2N.

Therefore, according to the settlement commission system 1 of the embodiment, without any independent connections between the many portal sites and the many financial institutions, it is possible to batch-process settlements with a plurality of financial institutions, which are generated by sales transactions at a plurality of portal sites.

Furthermore, a program for achieving each processing of the settlement commission apparatus 5 in the above-described settlement commission system 1 can be saved in a recording medium. By allowing a computer system to read from the recording medium, each processing of the settlement commission apparatus 5 can be achieved by executing the program and controlling the computer. In this case, the recording medium includes a device capable of recording programs, e.g., a memory, a magnetic disk device, an optical disk device or the like.

As obvious from appended claims, such inventions are also within the technical scope of the invention of this application.

### INDUSTRIAL APPLICABILITY

As described above, according to the settlement commission system of the present invention, it is possible to batch-process settlements with a plurality of financial institutions, which are generated by sales transactions at a plurality of portal sites, without any independent connections between the many portal sites and the many financial institutions.

What is claimed is:

1. A settlement commission method, in which transactions are carried out between a supplier for supplying goods and a buyer for buying the goods through a portal site using a computer system, and the commission of the settlement of charges generated by the transactions is executed by a server,
wherein the server totals the bills of charges generated in the transactions at the portal site, and when the buyer makes an entry to the effect of accepting a charged amount of the bills to the server, the server instructs a buyer-specified financial institution specified by the buyer to send the charged amount to a supplier-specified financial institution specified by the supplier.

2. The settlement commission method according to claim 1, wherein when the buyer makes an entry to the effect of accepting the charged amount to the server, the server transmits verification of a payment amount sent by the buyer to the buyer-specified financial institution.

3. The settlement commission method according to one of claims 1 and 2, wherein when the server receives, from the buyer-specified financial institution, a remittance result of the remittance instructed to the buyer-specified financial institution, the server deletes the remittance instruction to generate a settlement result based on the remittance result, and notifies the settlement result to the buyer.

4. The settlement commission method according to one of claims 1 to 3, wherein the server notifies the bills of charges to the supplier, and allows the supplier to make selection among the bills of charges.

5. The settlement commission method according to one of claims 1 to 4, wherein the server receives processing states of the bills from the buyer, collects the processing states for each supplier, and notifies a result to the supplier.

6. A settlement commission apparatus for carrying out transactions between a supplier for supplying goods and a buyer for buying the goods through a portal site using a computer system, and for executing the commission of the settlement of charges generated by the transactions by a server, the apparatus comprising:
a charge detail information notifying means for receiving, from the portal site, charge detail information as information regarding a bill of charges generated in the transactions at the portal site, for collecting the charge detail information for each buyer and for notifying the information to each buyer; and
a remittance-instructing means for instructing, when the buyer makes an entry to the effect of accepting a charged amount of the charge detail information notified by the charge detail information notifying means, a buyer-specified financial institution specified by the buyer to send the charged amount to a supplier-specified financial institution specified by the supplier.

7. The settlement commission apparatus according to claim 6, further comprising a payment amount verification transmitting means for transmitting, when the buyer makes an entry to the effect of accepting the charged amount of the charge detail information notified by the charge detail information notifying means, verification of a payment amount sent by the buyer to the buyer-specified financial institution.

8. The settlement commission apparatus according to one of claims 6 and 7, further comprising a settlement result notifying means for receiving a remittance result of the remittance instructed by the remittance instructing means from the buyer-specified financial institution, for deleting the remittance instruction to generate a settlement result based on the remittance result, and for notifying the settlement result to the buyer.

9. The settlement commission apparatus according to one of claims 6 to 8, wherein the charge detail information notifying means notifies the charge detail information received from the portal site to the supplier, and allows the supplier to select the charge detail information.

10. The settlement commission apparatus according to one of claims 6 to 9, further comprising a processing state notifying means for receiving processing states of the charge detail information, which is notified to the buyer, from the buyer, for collecting the processing states for each supplier, and for notifying the collected processing states to the supplier.

11. A buyer terminal of a buyer for buying goods by carrying out transactions with a supplier for supplying the goods through a portal site using a computer system, wherein when a notice regarding bills for charges generated in the transactions at the portal site is received from a server, and the buyer makes an entry to the effect of accepting a charged amount of the bills, the server is allowed to instruct a buyer-specified financial institution specified by the buyer to send the charged amount to a supplier-specified financial institution specified by the supplier.

12. The buyer terminal according to claim 11, wherein when the buyer makes an entry to the effect of accepting the charged amount, the acceptance is transmitted to the server, and the server is allowed to transmit verification of a payment amount sent by the buyer to the buyer-specified financial institution.

13. The buyer terminal according to one of claims 11 and 12, wherein when the server receives a remittance result with respect to the remittance instruction of the charged amount, instructed by the buyer, from the buyer-specified financial institution, the server is allowed to delete the remittance instruction to generate a settlement result based on the remittance result, and the settlement result is received.

14. A supplier terminal of a supplier for providing information of goods to a portal site using a computer system and for selling goods by carrying out transactions with a buyer, wherein
the supplier is prompted to make a selection upon receiving bills of charges generated by transactions at the portal site from a server,
a result of the selection is transmitted to the server, and the server is able to execute the acceptance of a charged amount of the bills by the buyer, and
when the buyer accepts the charge amount, the server is able to instruct a buyer-specified financial institution specified by the buyer to send the charged amount to a supplier-specified financial institution specified by the supplier.

15. The supplier terminal according to claim 14, wherein the server receives processing states of the bills from the buyer, collects the processing states for each supplier, and the collected processing states are received.

16. A recording medium for recording a settlement commission program in a settlement commission apparatus for carrying out transactions between a supplier for supplying goods and a buyer for buying the goods through a portal site using a computer system, and for executing the commission of the settlement of charges generated by the transactions, the recording medium comprising:
a charge detail information notifying process for receiving, from the portal site, charge detail information as information regarding a bill of charges generated in the transactions at the portal site, for collecting the charge detail information for each buyer and for notifying the collected information to each buyer; and
a remittance instructing process for instructing, when the buyer makes an entry to the effect of accepting a charged amount of the charge detail information notified by the charge detail information notification, a buyer-specified financial institution specified by the buyer to send the charged amount to a supplier-specified financial institution specified by the supplier.

17. The recording medium for recording a settlement commission program in the settlement commission apparatus according to claim 16, further comprising a payment amount verification transmitting process for transmitting, when the buyer makes an entry to the effect of accepting the charged amount of the charge detail information notified by the charge detail information notification, payment amount verification sent by the buyer to the buyer-specified financial institution.

18. The recording medium for recording a settlement commission program in the settlement commission apparatus according to one of claims 16 and 17, further comprising a settlement result notifying process for receiving a remittance result with respect to a remittance instruction instructed by the remittance instruction process from the buyer-specified financial institution, for deleting the remittance instruction to generate a settlement result based on the remittance result, and for notifying the settlement result to the buyer.

19. The recording medium for recording a settlement commission program in the settlement commission apparatus according to one of claims 16 to 18, wherein the charge detail information notifying process notifies the charge detail information received from the portal site to the supplier, and allows the supplier to make a selection from the charge detail information.

20. The recording medium for recording a settlement commission program in the settlement commission apparatus according to one of claims 16 to 19, further comprising a processing state notifying process for receiving processing states, from the buyer, of the charge detail information notified to the buyer, for collecting the processing states for each supplier, and for notifying the collected processing states to the supplier.
